(19) United States
(12) Patent Application Publication
(10) Pub. No.: US 2026/0107141 A1
(43) Pub. Date: Apr. 16, 2026

(54) System and Method for Secure Mobile Authentication and Identity Sharing via Deep Linking Between Mobile Applications

(71) Applicant: Ankur Gupta, Fremont, CA (US)

(72) Inventor: Ankur Gupta, Fremont, CA (US)

(21) Appl. No.: 19/301,996

(22) Filed: Aug. 17, 2025

Related U.S. Application Data
(60) Provisional application No. 63/706,668, filed on Oct. 13, 2024.

(51) Int. Cl. H04W 12/06; H04W 12/30

(52) U.S. Cl. CPC H04W 12/06; H04W 12/30

(57) ABSTRACT

A method and system for authentication and identity sharing between mobile applications via deep linking is disclosed. A requesting application sends a deep link to an identity authentication application including a unique user identifier or requested attributes. The identity authentication application verifies the requesting application's identity, prompts the user for consent, and returns authentication results or approved identity information via a callback deep link. All operations occur entirely within mobile devices without browser redirection, and the system supports attribute-based sharing without exposing raw personally identifiable information.

### CROSS-REFERENCE TO RELATED APPLICATIONS

This application claims the benefit of U.S. Provisional Patent Application No. 63/706,668, filed on Oct. 13, 2024, the entirety of which is incorporated herein by reference.

### FIELD OF THE INVENTION

The present invention relates to authentication and identity management systems, and more particularly to a method and system for securely authenticating and sharing user identity information between mobile applications using direct application-to-application deep linking.

### BACKGROUND OF THE INVENTION

Conventional mobile authentication methods typically involve browser-based redirection, third-party authentication servers, or web-based OAuth/SAML flows. These approaches introduce user experience friction and potential security vulnerabilities.

Identity sharing between applications often requires transmitting raw personally identifiable information (PII) without fine-grained user consent or privacy controls.

Accordingly, there exists a need for a secure, direct, and user-consent-driven method for authentication and identity sharing between mobile applications that eliminates browser dependency and supports privacy-preserving attribute sharing.

### SUMMARY OF THE INVENTION

The invention provides a method and system in which a requesting mobile application initiates authentication or identity sharing by invoking a registered deep link URI handled by an identity authentication application on the same device.

The requesting application provides a verified user identifier, such as an email address or mobile phone number, in the deep link request. The identity authentication application verifies the request, prompts the user for consent, and returns a signed authentication assertion or approved identity information. The invention supports attribute-based sharing (e.g., age ≥18) without transmitting raw PII.

The method leverages operating system deep linking to enable direct application-to-application communication entirely within mobile environments, eliminating the need for browser redirection.

### BRIEF DESCRIPTION OF THE DRAWINGS

FIG. 1: System architecture illustrating components and communication paths.

FIG. 2: Sequence diagram of the authentication flow.

FIG. 3: Sequence diagram of the identity sharing flow with user consent.

FIG. 4: Example user consent interface displayed by the identity authentication application.

FIG. 5: Exemplary deep link URI formats for authentication requests, identity sharing requests, and callback responses.

### Drawings

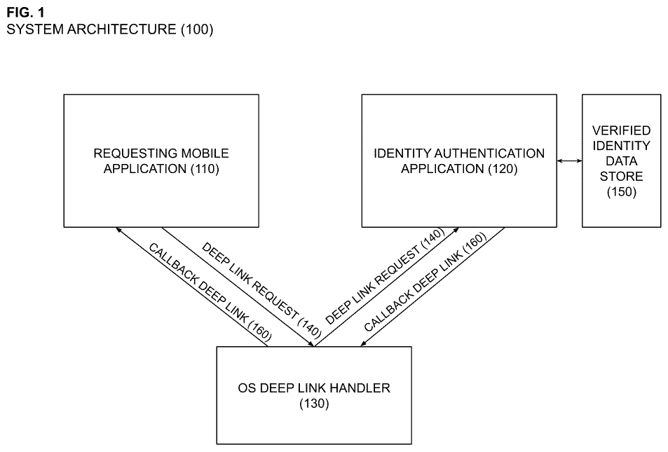

The drawings are provided separately as drawings.pdf and include FIGS. 1-5 as described above.

### DETAILED DESCRIPTION OF THE PREFERRED EMBODIMENTS

### System Components (Ref. FIG. 1)

The system 100 includes:
1. A requesting mobile application 110 that initiates authentication or identity sharing requests.
2. An operating system deep link handler 130 that routes incoming deep link URIs between applications.
3. An identity authentication application 120 that receives requests, verifies user identifiers against a verified identity store 150, and manages user consent.

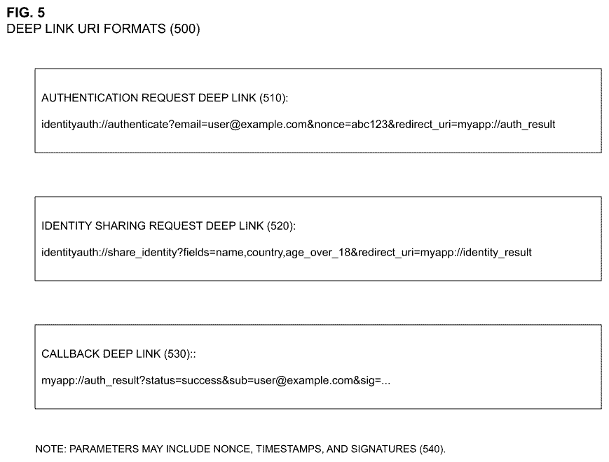

Requests 140 containing verified identifiers (e.g., email or mobile number), as specified in deep links 510 and 520 in FIG. 5, are sent from the requesting application 110 to the identity authentication application 120 through the OS deep link handler 130. The identity authentication application 120 verifies the identifiers by consulting the verified identity data store 150, and returns authentication results or approved identity information 160 via callback deep link corresponding to 530 in FIG. 5.

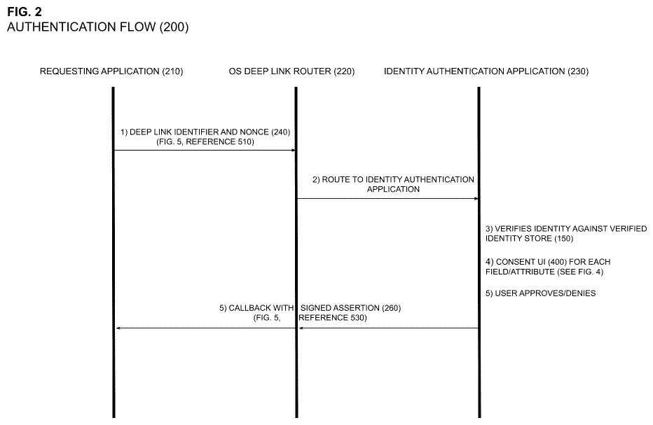

### Authentication Flow (Ref. FIG. 2)

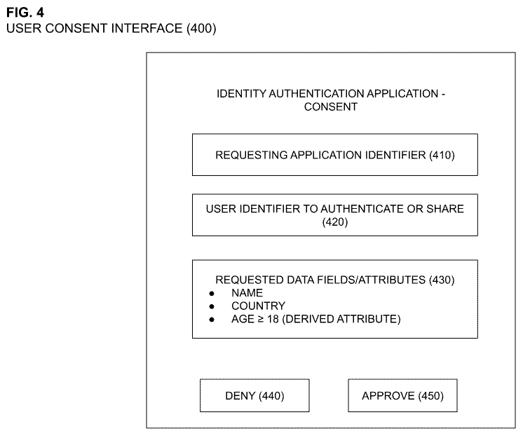

1. The requesting application 210 sends an authentication request deep link 240 corresponding to deep link 510 in FIG. 5, containing a verified user identifier (e.g., email or mobile number) and a callback URI to the operating system deep link router 220.
2. The OS deep link router 220 forwards the request to the identity authentication application 230.
3. The identity authentication application 230 verifies the requesting application's identity and matches the user identifier against the verified identity store 150.
4. The user is presented with a consent user interface 400 (see FIG. 4) to approve or deny the authentication request.
5. Upon user approval, the identity authentication application 230 sends a signed authentication assertion and the confirmed user identifier back to the requesting application 210 via callback deep link 260 corresponding to 530 in FIG. 5.

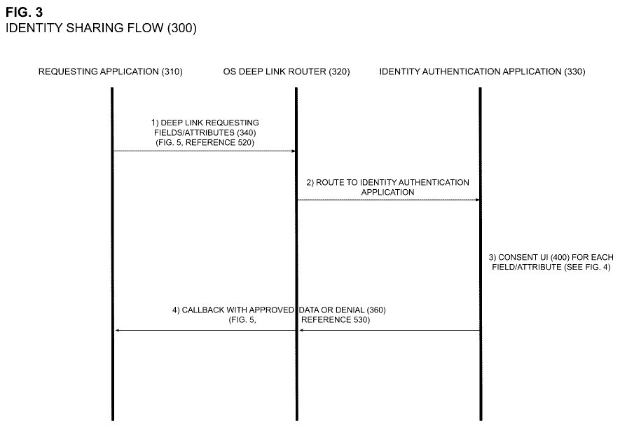

### Identity Sharing Flow with Derived Attributes (Ref. FIG. 3)

1. The requesting application 310 sends an identity sharing request deep link 340 corresponding to deep link 520 in FIG. 5, specifying requested fields or derived attributes (e.g., age ≥18) to the OS deep link router 320.
2. The OS deep link router 320 routes the request to the identity authentication application 330.
3. The identity authentication application 330 presents a consent user interface 400 (FIG. 4) allowing the user to approve or deny sharing each requested data field or attribute.
4. The identity authentication application 330 returns the approved identity information or derived attribute assertions via callback deep link 360 corresponding to 530 in FIG. 5.

### User Consent Interface (Ref. FIG. 4)

The identity authentication application displays a consent interface 400 including:
1. The name or identifier of the requesting application 410.
2. The user identifier to be authenticated or shared 420.
3. The list of requested identity data fields and derived attributes 430.
4. Controls to approve 450 or deny 440 the request.

### Deep Link URI Formats (Ref. FIG. 5)

1. Authentication request deep links 510:
   identityauth://authenticate?
   email=user@example.com&nonce=abc123&redirect_uri=myapp://auth_result
2. Identity sharing request deep links 520:
   identityauth://share_identity?
   fields=name,country,age_over_18&redirect_uri=myapp://identity_result
3. Callback deep links 530:
   myapp://auth_result?status=success&sub=user@example.com&sig= . . .

### Claims

### Independent Claims

Claim 1: A method for authentication between mobile applications, comprising:
receiving, by an identity authentication mobile application, a deep link request from a requesting mobile application, the deep link request including a unique user identifier comprising at least one of a verified email address or a verified mobile phone number;
verifying the requesting mobile application's identity;
matching the unique user identifier against stored, verified identifiers of a user of the identity authentication mobile application;
prompting the user to approve or deny the authentication request; and
upon approval, transmitting, via a deep link callback to the requesting mobile application, an authentication result and the confirmed unique user identifier.

Claim 2: A method for identity sharing between mobile applications, comprising:
receiving, by an identity authentication mobile application, a deep link request from a requesting mobile application, the deep link request including a specification of requested identity fields or derived attributes;
verifying the requesting mobile application's identity;
prompting the user to approve or deny sharing of each requested field or attribute; and
upon approval, transmitting, via a deep link callback, the approved identity fields or derived attributes to the requesting mobile application.

Claim 3 (System Claim): A system for authentication and identity sharing between mobile applications, comprising:
a requesting mobile application configured to generate a deep link request including a unique user identifier;
an identity authentication application configured to receive the deep link request, verify the requesting application's identity, and manage user consent; and
an operating system deep link handler configured to route the deep link request between the requesting application and the identity authentication application, wherein the identity authentication application is further configured to transmit an authentication result or approved identity attributes to the requesting application via a callback deep link.

### Dependent Claims

Claim 4: The method of claim 1, wherein the deep link request includes a callback URI for receiving the authentication result.

Claim 5: The method of claim 1, wherein verifying the requesting mobile application comprises validating its package name and digital signature.

Claim 6: The method of claim 2, wherein derived attributes include age verification or country confirmation without revealing raw personally identifiable information.

Claim 7: The method of claim 1, wherein the deep link communication occurs without invoking a web browser.

A method and system for authentication and identity sharing between mobile applications via deep linking is disclosed. A requesting application sends a deep link to an identity authentication application including a unique user identifier or requested attributes. The identity authentication application verifies the requesting application's identity, prompts the user for consent, and returns authentication results or approved identity information via a callback deep link. All operations occur entirely within mobile devices without browser redirection, and the system supports attribute-based sharing without exposing raw personally identifiable information.

1. A method for authentication between mobile applications, comprising:
receiving, by an identity authentication mobile application, a deep link request from a requesting mobile application, the deep link request including a unique user identifier comprising at least one of a verified email address or a verified mobile phone number;
verifying the requesting mobile application's identity;
matching the unique user identifier against stored, verified identifiers of a user of the identity authentication mobile application;
prompting the user to approve or deny the authentication request; and
upon approval, transmitting, via a deep link callback to the requesting mobile application, an authentication result and the confirmed unique user identifier.

2. A method for identity sharing between mobile applications, comprising:
receiving, by an identity authentication mobile application, a deep link request from a requesting mobile application, the deep link request including a specification of requested identity fields or derived attributes;
verifying the requesting mobile application's identity;
prompting the user to approve or deny sharing of each requested field or attribute; and
upon approval, transmitting, via a deep link callback, the approved identity fields or derived attributes to the requesting mobile application.

3. A system for authentication and identity sharing between mobile applications, comprising:
a requesting mobile application configured to generate a deep link request including a unique user identifier;
an identity authentication application configured to receive the deep link request, verify the requesting application's identity, and manage user consent; and
an operating system deep link handler configured to route the deep link request between the requesting application and the identity authentication application, wherein the identity authentication application is further configured to transmit an authentication result or approved identity attributes to the requesting application via a callback deep link.

4. The method of claim 1, wherein the deep link request includes a callback URI for receiving the authentication result.

5. The method of claim 1, wherein verifying the requesting mobile application comprises validating its package name and digital signature.

6. The method of claim 2, wherein derived attributes include age verification or country confirmation without revealing raw personally identifiable information.

7. The method of claim 1, wherein the deep link communication occurs without invoking a web browser.
